(19) United States
(12) Patent Application Publication
(10) Pub. No.: US 2021/0250414 A1
(43) Pub. Date: Aug. 12, 2021

(54) METHODS AND SYSTEMS FOR FACILITATING COMMUNICATION BETWEEN USERS AND DESTINATION USERS USING DIFFERENT COMMUNICATION CHANNELS

(71) Applicant: 2R2N LLC, North Miami Beach, FL (US)

(72) Inventors: Rafael Miguel Arribalzaga, Ciudad de Buenos Aires (AR); Julieta Sanna, Ciudad de Buenos Aires (AR)

(21) Appl. No.: 17/173,081

(22) Filed: Feb. 10, 2021

Related U.S. Application Data
(60) Provisional application No. 62/972,631, filed on Feb. 10, 2020.

(51) Int. Cl. H04L 29/08

(52) U.S. Cl. CPC H04L 67/26; H04L 67/02; H04L 67/306; H04L 67/22; H04L 67/147

(57) ABSTRACT

Disclosed herein is a method for facilitating communication between users and destination users using different communication channels. Accordingly, the method may include receiving, using a communication device, event data associated with an event from a user device associated with a user, analyzing, using a processing device, the event data, generating, using the processing device, a campaign for the event based on the analyzing, identifying, using the processing device, a destination user associated with the campaign based on the generating of the campaign, receiving, using the communication device, a content associated with the campaign from the user device, formatting, using the processing device, the content based on a communication channel associated with the campaign, generating, using the processing device, a message based on the formatting, transmitting, using the communication device, the message to a destination user device associated with the destination user, and storing, using a storage device, the message.

The current application claims a priority to the U.S. provisional patent application Ser. No. 62/972,631 filed on Feb. 10, 2020.

### FIELD OF THE INVENTION

Generally, the present disclosure relates to the field of data processing. More specifically, the present disclosure relates to methods and systems for facilitating communication between users and destination users using different communication channels.

### BACKGROUND OF THE INVENTION

Due to the increasing capacity and capability of cloud software, it has become popular to use a different type of integrated services as a repository of digital tools for software like CRM customer relationship management solutions or ERP enterprise resource planning, etc. The increasing market demand makes every organization tend towards cross-channel and omnichannel strategies in both mass communication and one-to-one communication. Clients use multiple ways for contacting each other and the information, as well as actions directed to audiences, must be centralized, beyond the channel.

Therefore, there is a need for improved methods and systems for facilitating communication between users and destination users using different communication channels that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating communication between users and destination users using different communication channels, in accordance with some embodiments. Accordingly, the method may include receiving, using a communication device, event data associated with an event from at least one user device associated with at least one user. Further, the method may include analyzing, using a processing device, the event data. Further, the method may include generating, using the processing device, at least one campaign for the event based on the analyzing. Further, the at least one campaign may be characterized by at least one communication channel. Further, the method may include identifying, using the processing device, at least one destination user associated with a campaign of the at least one campaign based on the generating of the at least one campaign. Further, the method may include receiving, using the communication device, at least one content associated with the campaign from the at least one user device. Further, the method may include formatting, using the processing device, the at least one content based on a communication channel of the at least one communication channel associated with the campaign. Further, the method may include generating, using the processing device, at least one message associated with the campaign based on the formatting. Further, the at least one message may be characterized by a message type corresponding to the communication channel. Further, the method may include transmitting, using the communication device, the at least one message to at least one destination user device associated with the at least one destination user. Further, the method may include storing, using a storage device, the at least one message.

Further disclosed herein is a system for facilitating communication between users and destination users using different communication channels, in accordance with some embodiments. Accordingly, the system may include a communication device configured for receiving event data associated with an event from at least one user device associated with at least one user. Further, the communication device may be configured for receiving at least one content associated with the campaign from the at least one user device. Further, the communication device may be configured for transmitting at least one message to at least one destination user device associated with at least one destination user. Further, the system may include a processing device communicatively coupled with the communication device, the processing device may be configured for analyzing the event data. Further, the processing device may be configured for generating at least one campaign for the event based on the analyzing. Further, the at least one campaign may be characterized by at least one communication channel. Further, the processing device may be configured for identifying the at least one destination user associated with a campaign of the at least one campaign based on the generating of the at least one campaign. Further, the processing device may be configured for formatting the at least one content based on a communication channel of the at least one communication channel associated with the campaign. Further, the processing device may be configured for generating the at least one message associated with the campaign based on the formatting. Further, the at least one message may be characterized by a message type corresponding to the communication channel. Further, the system may include a storage device communicatively coupled with the processing device. Further, the storage device may be configured for storing the at least one message.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a schematic of an architecture environment associated with a system for facilitating communication between users and destination users using different communication channels, in accordance with some embodiments.

FIG. 2 is a flow diagram of a sample massive campaign execution flow, in accordance with some embodiments.

FIG. 3 is a flow diagram of a method for facilitating massive campaign state transition, in accordance with some embodiments.

FIG. 4 is a flow diagram of a sample transactional message execution flow, in accordance with some embodiments.

FIG. 5 is a screenshot of a sample landing page generated with the Owned Web Channels Engine, in accordance with some embodiments.

FIG. 6 is a flow diagram of a method for dynamic landing page creation sequence, in accordance with some embodiments

FIG. 7 is a flow diagram of a method for landing page execution, in accordance with some embodiments.

FIG. 8 illustrates a sample dynamic QR usage flow, in accordance with some embodiments.

FIG. 9 is a flow diagram of a method for facilitating event creation, in accordance with some embodiments.

FIG. 10 is a schematic of a method for building a unified contact profile, in accordance with some embodiments.

FIG. 11 is a flowchart of a method for facilitating communication between users and destination users using different communication channels, in accordance with some embodiments.

FIG. 12 is a flowchart of a method for determining a triggering condition for facilitating the communication between the users and the destination users using different communication channels, in accordance with some embodiments.

FIG. 13 is a flowchart of a method for generating a status message for facilitating the communication between the users and the destination users using different communication channels, in accordance with some embodiments.

FIG. 14 is a flowchart of a method for determining at least one action for facilitating the communication between the users and the destination users using different communication channels, in accordance with some embodiments.

FIG. 15 is a flowchart of a method for determining the communication channel for facilitating the communication between the users and the destination users using different communication channels, in accordance with some embodiments.

FIG. 16 is a flowchart of a method for determining the communication channel for facilitating the communication between the users and the destination users using different communication channels, in accordance with some embodiments.

FIG. 17 is a flowchart of a method for determining the communication channel for facilitating the communication between the users and the destination users using different communication channels, in accordance with some embodiments.

FIG. 18 is a flowchart of a method for determining a communication method for facilitating the communication between the users and the destination users using different communication channels, in accordance with some embodiments.

FIG. 19 is a flowchart of a method for determining a proximity for facilitating the communication between the users and the destination users using different communication channels, in accordance with some embodiments.

FIG. 20 is a block diagram of a system for facilitating communication between users and destination users using different communication channels, in accordance with some embodiments.

FIG. 21 is an illustration of an online platform consistent with various embodiments of the present disclosure.

FIG. 22 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating communication between users and destination users using different communication channels—embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview

The present disclosure describes methods and systems for facilitating communication between users and destination users using different communication channels. Further, TelecomPlay™ (an embodiment of the disclosed system herein) is a Cloud Telecommunications and Automation Hub that allows the use of global carriers in Customer Service, Sales Corps, Marketing and communication actions.

TelecomPlay™ integrates into a single SaaS platform, channels such as mass and transactional email, SMS, automated IVR, callback, call forwarding and routing from regional telephones and VoIP, audio telephone broadcast, cookies for audience tagging, administration, and management of dynamic reference QRs and NFC tags (Near Field Communication Tags), triggers and automated cross-channel communication sequences. Landing page forms for lead capturing and nurturing, surveys and feedback. Further, the disclosed system may be configured for complete event management from audience announcements, pre-registration, on-site attendance, and post-event greetings.

Due to the increasing capacity and capability of cloud software, it has become popular to use a different type of integrated services as a repository of digital tools for software like CRM customer relationship management solutions or Enterprise Resource Planning (ERP), etc. The increasing market demand makes every organization tend towards cross-channel and omnichannel strategies in both mass communication and one-to-one communication. Clients use multiple ways for contacting each other and the information, as well as actions directed to audiences, must be centralized, beyond the channel. Further, the disclosed system may provide an automated, non-technical human resources skills consultant, adaptable, integrated, predictive, multi-telecom carrier, cloud service with centralized data, with any type of software that is installed as well as a stand-alone service.

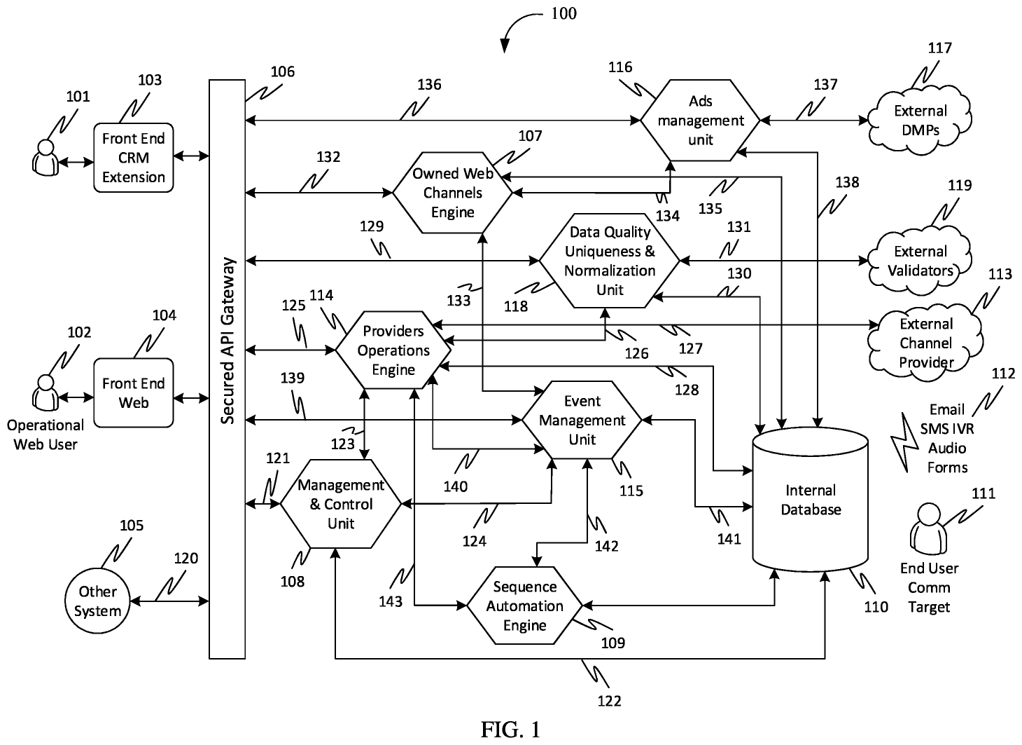

Referring now to figures, FIG. 1 is a schematic of an architecture environment associated with a system 100 for facilitating communication between users and destination users using different communication channels, in accordance with some embodiments. Accordingly, the system 100 (such as the system 2000) may include three kinds of frontends. Further, the three kinds of frontends may include a CRM frontend client (CRM frontend) 103, a custom autonomous web frontend 104, and secured API access to be accessed by other systems 105, through a secured REST API.

Further, both the CRM frontend client 103 or the Web frontend 104, has methods and procedures to expose to an Operational CRM User 101, or an Operational Web User 102, a functional user interface that permits the operation of every functional module disclosed by the embodiment of a Secured API Gateway 106. This includes, but is not limited to, handling massive communication campaigns, transactional notification rules definitions, creation and managing of QR, short links, and NFC tags, Ads management, monitoring the execution progress of related processes, displaying reports, and summary analytic indicators. Create and edit rich HTML content using a visual HTML page builder. Create and define parameters for dynamic landing page forms and surveys.

In particular, the CRM frontend client 103, may be considered an extension of the supporting CRM platform and takes advantage of the available resources, its standard data structure, its processes, and standard functionality and is consistent with its own user interface experience.

Further, the kind of frontends may be supported by a Secured API Gateway 106, which serves and exposes to it every single functionality. The other main components are placed behind the Secured API Gateway 106, forming a backend.

Further, the backend may be made of different modules. Further, a providers Operations Engine 114 may handle all electronic marketing campaign executions, all transactional executions, and manage all delivery status information. To perform its duties it works closely with a Management and Control Unit 108 that may manage all the account information, available credits, and licensing information for a current user in operation (Operational CRM User 101, Operational Web User 102, or Other systems 105 through an API User).

Further, the Providers Operations Engine 114, may drive all the communications through the External Channel Providers 113, which are 3rd party Providers, external to the system 100, and responsible for delivering the communicational media to the destinations (a destination user, an end-user, a target user, an audience, etc.) 111, using their corresponding channels 112, and retrieving the delivery statuses available for each of those channels 112 back to the Providers Operations Engine 114, using synchronous request results, asynchronous callbacks or accessing exposed retrieval REST APIs of their own.

For instance, the Providers Operations Engine 114 may implement methods and processes for accessing and make use of Facebook Custom Audience Marketing API, as an External Channel Providers 113, to create and take advantage of its targeting and ads displaying functionality.

Further, the Providers Operations Engine 114, implements and expose methods to capture from external data sources formerly External Channel Providers 113, contact and survey information, for example retrieving information from Facebook Lead Ads Marketing API.

Further, the Providers Operations Engine 114, executes massive communicational techniques and methods, as well as transactional communicational techniques and methods. They both have different requirements and are explained in further detail later on.

Further, a Sequence Automation Engine 109, may be responsible for defining and managing customizable criteria for automated processing which can trigger immediate and scheduled actions, like sending a scheduled email on form completion, or sending an SMS if a QR was scanned and accessed.

Further, the Owned Web Channels Engine 107, may handle the definition and dynamic generation and host of web resources like forms and surveys. Further, the owned web channels engine 107 allows any single user without developer skills, the creation of web forms and web surveys in real-time, defining its layout, styles, mixing fields for capturing contact information, like name, email, address, age, or any other field related to a contact, survey driven questions including but not limited to text input questions, number input question, range input questions, list selection questions, mutually exclusive options, multiple selection options, and qualification grades with stars. The user can dynamically customize the field attributes like if it's required, it has a default value or a placeholder text.

Further, the Owned Web Channels Engine 107 may provide methods and processes for generating and hosting QR images, and produce dynamic QR, short-links and NFCs managed links. It's also responsible for retrieving their access statistics, survey, and form answers.

Further, an Event Management Unit 115 may pick up the event definition from the incoming request and generates an Event with a related general Campaign, with a set of members. It allows the creation of several sub-campaigns of different types.

Further, the Event Management Unit 115 may interact with the Sequence Automation Engine 109, to define conditional workflows related to a particular event, which in turn triggers transactional actions.

Further, the Management & Control Unit 108, handles all the specific account duties, like the following functions but not limiting to them: user license provisioning, adding or deducting consumable credits to its account balance, validating enough credits available for execution, providing real-time account information to the frontends, default channel quality preferences, as the same delivery service can be provided in different quality levels, a standard service using providers which has regular “good to go” performance with a low credits/delivery ratio, and on the other hand, a premium high performant service using providers which has a much better performance with a greater credits/delivery ratio.

Further, a Data Quality, Uniqueness & Normalization Unit 118, may have a moduled functionality that may be used by the Providers Operations Engine 114, to clean, normalize and validate contact information. For example, normalizing phone numbers using external libraries hosted on 3rd parties cloud services 119, or syntactically validating email address correctness using some embodiment of regular patterns matching, or for example to verify if a provided campaign has no members with duplicated contact information, like two contact members with the same email address in the same delivery.

Further, the Data Quality, Uniqueness & Normalization Unit 118, may be responsible for defining customized uniqueness criteria for a single contact based on its fields.

Further, the Ads Management Unit 116, provides the methods and procedures to interact with an external DMP provider 117, defining segments and tags taxonomies for the account first-party data. It's responsible for implementing a cookie, pixel, or any other kind of tagging technology from the external DMP provider 117, named a DMP Id for simplicity, that permits the unique identification of such occurrence in the DMP, and makes those DMP Ids available for use in every form and survey media generated by Owned Web Channels Engine 107.

Further, the Ads Management Unit 116, defines methods and algorithms to match a submitted contact form information to the corresponding displayed tag. This way first-party data client-owned segmentation is identified.

Further, the Ads Management Unit 116, provides methods to identify the DMPs and retrieve all relevant and available segmentations and tags for a set of provided pixels, cookies, or DMP Ids.

Further, the Ads Management Unit 116, has methods and procedures to persist those segments and tags on the internal database system (internal database) 110.

Further, all backend modules persist and retrieve information from/to an internal database 110, that may keep tracking information, contact campaign participation, scheduling and workflow information, statistics information, account, and licensing information, and every relevant data required by the whole platform operation.

Further, at 120, other systems 105 may interact with the Secured API gateway 106 using Secured API access. Further, at 121, the management and control unit 108 may transmit and receive a license and credits information. Further, at 122, the management and control unit 108 may retrieve and store delivery information accounts and credits information in the internal database 110. Further, at 123, the management and control unit 108 may transmit and receive the delivery information accounts and credits information from the providers operations engine 114. Further, at 124, the management and control unit 108 may transmit and receive the delivery information accounts and credits information from the event management engine (unit) 115. Further, at 125, the providers operations engine 114 may receive and transmit campaign executions, transactional executions, delivery status information. Further, at 126, the providers operations engine 114 may receive and transmit a members campaign to the data quality, uniqueness and normalization unit 118. Further, at 127, the providers operations engine 114 may receive and transmit the campaign execution information and delivery status information to the external channel providers 113. Further, at 128, the providers operations engine 114 may store and retrieve campaign member and the delivery status information to the internal database 110. Further, at 129, the data quality, uniqueness and normalization unit 118 may receive and transmit validation requests. Further, at 130, the data quality, uniqueness and normalization unit 118 may validate contact information. Further, at 131, the data quality, uniqueness and normalization unit 118 may transmit and receive emails to validate, phones to validate, and addresses to validate to the external validators 119. Further, at 132, the owned web channels engine 107 may transmit and receive forms/surveys. Further, at 133, the owned web channels engine 107 may transmit and receive registration form, confirmation form, and attendance QR to the event management unit 115. Further, at 134, the owned web channels engine 107 may transmit and receive landing forms to the ads management unit 116. Further, at 135, the owned web channels engine 107 may retrieve and store forms, survey submissions, short links, and QR image to the internal database 110. Further, at 136, the ads management unit 116 may receive and transmit segment tags taxonomies. Further, at 137, the ads management unit 116 may receive and transmit segment cookies to the external DMP provider 117. Further, at 138, the ads management unit 116 may retrieve and store tags to the internal database 110. Further, at 139, the event management unit 115 may receive and transmit event generation. Further, at 140, the event management unit 115 may receive and transmit managed executions to the providers operations engine 114. Further, at 141, the event management unit 115 may store and retrieve event and sub-campaign information to the internal database 110. Further, at 142, the event management unit 115 may receive and transmit scheduled actions to the sequence automation engine 109. Further, at 143, the sequence automation engine 109 may receive and transmit the sub-campaign executions to the providers operations engine 114.

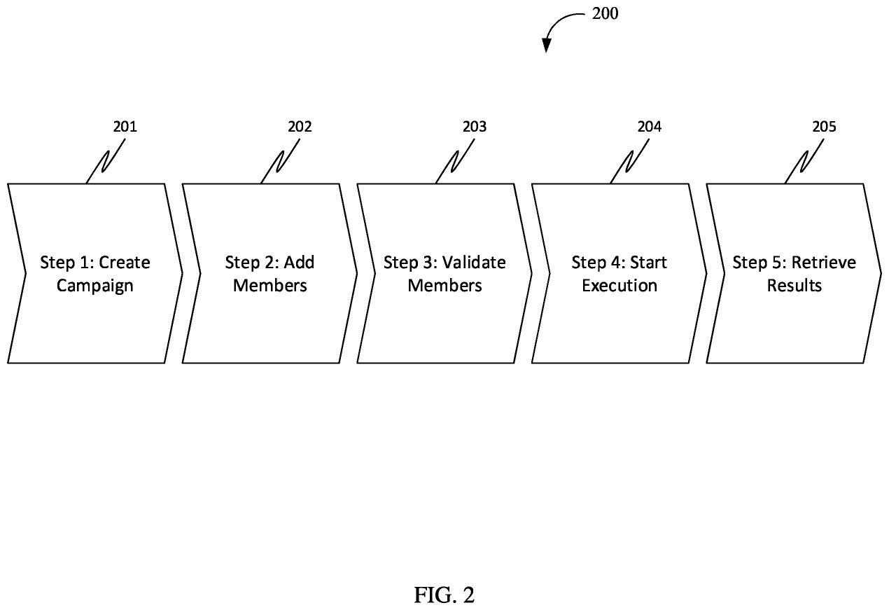

FIG. 2 is a flow diagram of a sample massive campaign execution flow 200, in accordance with some embodiments. Accordingly, at 201, on every execution, the sample massive campaign execution flow 200 may include campaign creation. Further, an electronic marketing campaign may be created providing several parameters required for its execution, that includes but is not limited to a campaign name, start date and time, its delivery channel, the delivery intended quality (standard/premium). Depending on channel selection, a message or body content may be provided, even a subject or an IVR tree definition with its corresponding audio files is provided.

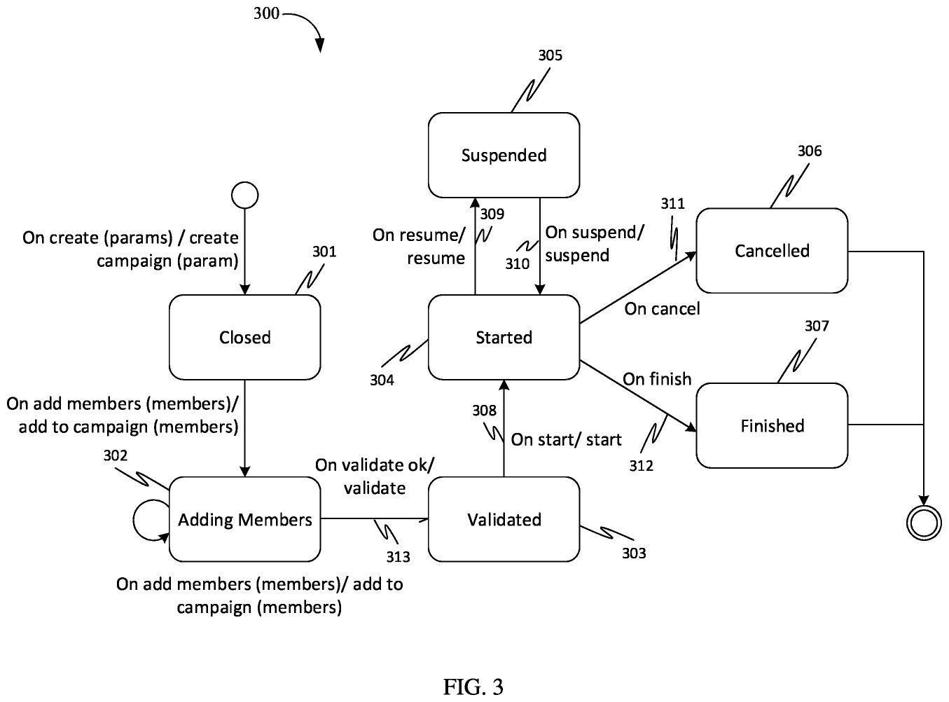

Upon creating the campaign, at 202, the sample massive campaign execution flow 200 may include adding members to the campaign. Further, the Providers Operations Engine 114 may add a single member as well as a bulk of members in several batches having the opportunity to repeat them and interleave one and the other. Further, in an embodiment, the CRM frontend 103 may take advantage of standard CRM segmentation and campaign membership functionality to group the targeted members. Further, in an embodiment, the Web frontend 104 may upload a CSV file with the required member contact information fields and has a user interface for manually add a single member to the campaign. The campaign may be transitioned to a state Adding Members 302 (as shown in FIG. 3).

Further, at 203, the sample massive campaign execution flow 200 may include validating members. Further, a contact membership may be verified looking for members with duplicate contact information, members with incorrect or malformed contact information. Further, in an embodiment, the Data Quality, Uniqueness & Normalization Unit 118, also validates and applies uniqueness control and enrichment of uncompleted fields for the current contact information owned by the client. Every incorrect, malformed, or not a valid member may be moved out of the campaign and grouped in a sub-campaign dedicated to invalid members with a description of the reason it was identified as invalid. The campaign is transitioned to a state Validated 303 (as shown in FIG. 3).

Further, at 204, the sample massive campaign execution flow 200 may include the start execution of the campaign. Further, the Providers Operations Engine 114 may start executing and delivering the campaign media at the time specified by the start date-time campaign parameter, configured during campaign creation. The campaign transitions to a state Started 304 (as shown in FIG. 3). Further, in an embodiment, the Providers Operations Engine 114 may provide methods and procedures to suspend the campaign transitioning to a state Suspended 305 (as shown in FIG. 3), and to resume its execution later taking it back to the state Started 304.

Further, at 205, the sample massive campaign execution flow 200 may include retrieving results. Once the campaign has been started executing and delivering its content through the External Channel Providers 113, the Providers Operations Engine 114 may start collecting delivery statistics from them, retrieve the results.

The campaign continues its execution until all its members had been processed, transitioning to a final state Finished 307 (as shown in FIG. 3). Further, in an embodiment, the Providers Operations Engine 114 may provide methods and processes to stop the execution at any time, in which case the campaigns transition immediately to a final state Canceled 306 (as shown in FIG. 3).

FIG. 3 is a flow diagram of a method 300 for facilitating massive campaign state transition, in accordance with some embodiments. Accordingly, at 301, the method 300 may include a closed state upon creating a campaign (or create param). Further, at 302, the method 300 may include the state adding members to the campaign. Further, at 303, the method 300 may include the state validated. Further, at 313, the method 300 may include validation. Further, at 308, the method 300 may include on start. Further, at 304, the method 300 may include the state started. Further, at 309, the method 300 may include on resume. Further, at 305, the method 300 may include the state suspended. Further, at 310, the method 300 may include on suspend. Further, at 311, the method 300 may include on cancel. Further, at 312, the method 300 may include finish. Further, at 306, the method 300 may include the final state cancelled. Further, at 307, the method 300 may include the final state finished.

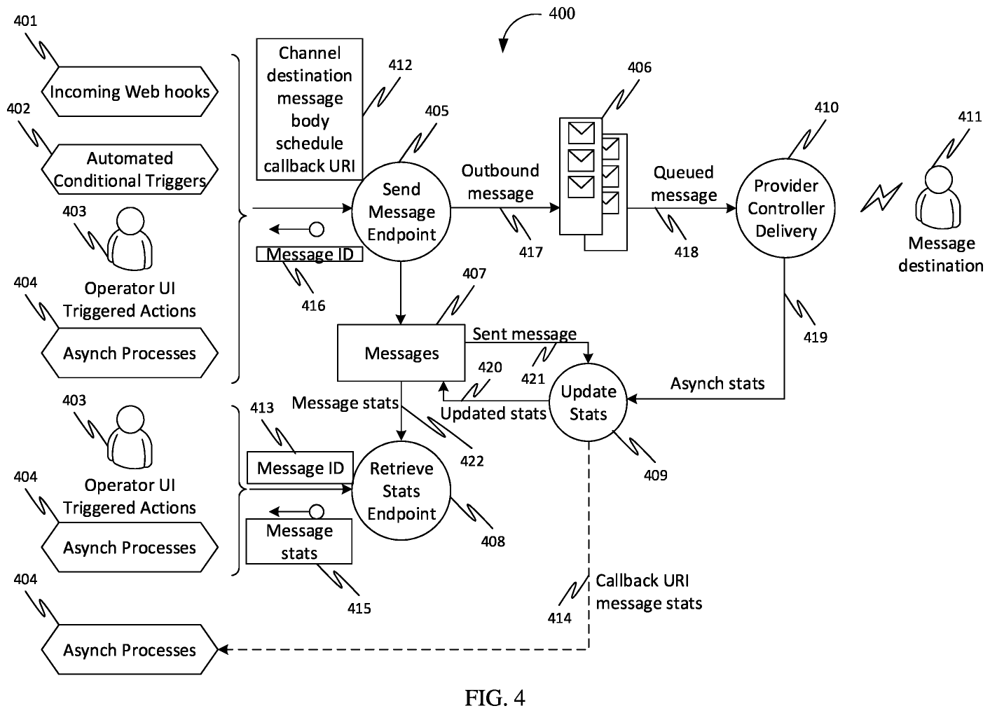

FIG. 4 is a flow diagram of a sample transactional message execution flow 400, in accordance with some embodiments. Accordingly, the Secured API Gateway 106 may expose methods and endpoints 401 to allow different frontends such as the CRM frontend 103, the Web frontend 104, and the Web frontend of the other systems 105 to send a notification to a single destination. Further, in an embodiment, the CRM frontend 103 may allow an operating user to send a single notification for a particular channel from the user interface of the supporting platform (user interface) 403, and has methods and processes to make notifications from asynchronous processes 404 of its own, both making use of the endpoints 401. On the other hand, an embodiment of the Sequence Automation Engine 109 implements actions and methods to allow automated conditional triggers 402, to send notifications from inside the backend.

Every notification request 412 is composed at least by the following information, even though they are not limited to, communicational channel, destination contact, information, message body or content, schedule for delivery, and callback URL.

Further, a request (such as the notification request 412) may be processed by an embodiment of a Send Message Endpoint process 405, which handles the formatting and delivery of the message into an embodiment of a message queue 406 for delivery. This process persists in the internal database 110 the message itself in a message store 407 so it can be followed up later on. This process also returns a message Id to a caller 416, identifying the requested message. Further, at 417, the sample transactional message execution flow 400 may include an outbound message. Further, at 418, the sample transactional message execution flow 400 may include a queued message. Further, at 419, the sample transactional message execution flow 400 may include asynch stats. Further, at 420, the sample transactional message execution flow 400 may include updated stats. Further, at 421, the sample transactional message execution flow 400 may include a sent message. Further, at 422, the sample transactional message execution flow 400 may include message stats.

Further, in an embodiment, the Providers Controller Delivery process 410 may facilitate popping out of the message queue 406 a message and sending it through the right provider and channel to a message destination 411. This embodiment eventually updates asynchronously the status of such delivery triggering an embodiment of an Update Stats process 409. This update process retrieves the message from the message store 407, updates the status, and persists the updated message back to the message store 407. It also fires a callback to the endpoint defined in the callback URI parameter for the corresponding message at 414.

Further, in an embodiment, the CRM frontend 103, the Web frontend 104, and the Web frontend of the other systems 105 may facilitate retrieving notification status for the delivered message, either by actions triggered from the user interface 403, or from the asynchronous processes 404. The requests may be received and processed by an embodiment of Retrieve Stats Endpoint 408, identifying the message to a process by a message ID parameter 413, this process retrieves the corresponding message status from the message store 407 and returns the stats to a request caller 415.

Further, the Send Message Endpoint process 405, the Providers Controller Delivery process 410, the update Stats process 409, and the retrieve Stats Endpoint 408, have a place and are part of a containing embodiment of the Providers Operations Engine 114.

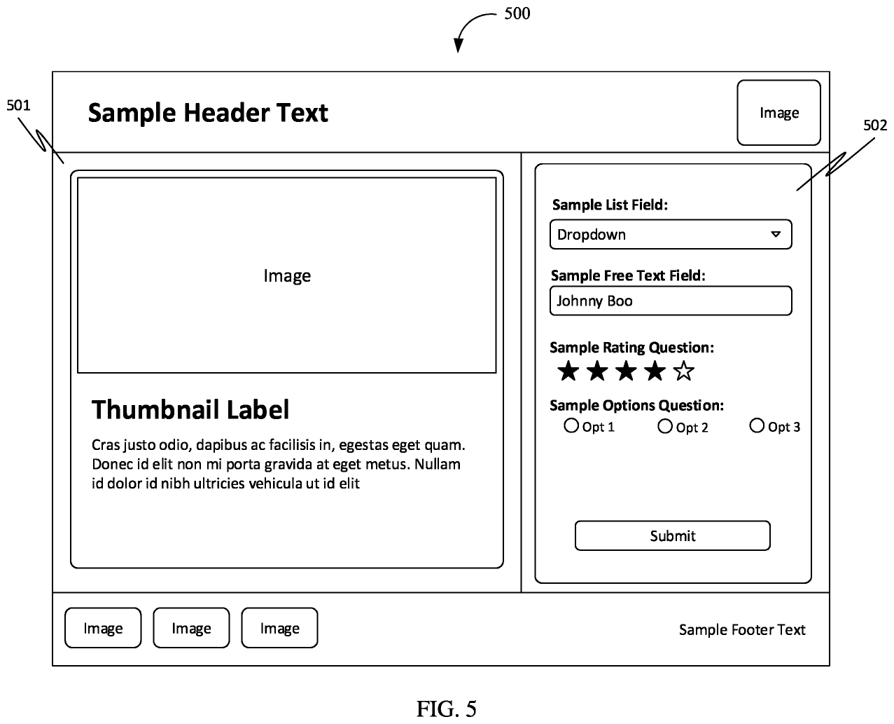

FIG. 5 is a screenshot of a sample landing page 500 generated with the Owned Web Channels Engine 107, in accordance with some embodiments. Accordingly, the generated sample landing page 500 may include a custom layout 501, built using an embodiment of the frontends such as the CRM frontend 103 and the Web frontend 104 with a user interface that implements a fully visual HTML web builder. As a component module of the sample generated landing page 500, is placed a sample form which dynamically renders its corresponding contact fields and questions for a sample survey 502. The dynamic rendering makes use of existing javascript libraries which take a form definition in a JSON expression and renders it using Javascript/HTML/CSS methods.

Further, an objective of the sample landing page forms may be, which are not limited to, contact capture and nurturing as well as providing a method for custom confirmation forms, attendance forms, feedback and comments forms, custom unsubscription forms, and survey forms.

Further, in an embodiment of the visual HTML Web Builder within Owned Web Channels Engine 107 may include the following features, but not limited to Customizable HTML Layout, customizable CSS, post submit Text, post submit URL redirect, atomic layout-relocatable form/survey component based on a target contact object data structure, user-selected predefined fields, questions and comments to display, auto field type detection and formatting, auto select list filling based on targeted object fields, dynamic form rendering by Json parameters, and bulk on demand result update

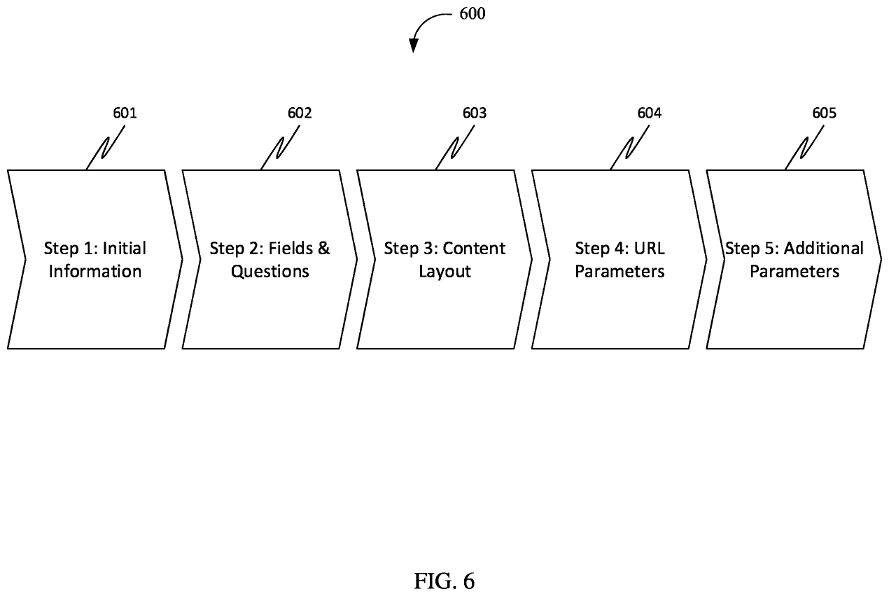

FIG. 6 is a flow diagram of a method 600 for dynamic landing page creation sequence, in accordance with some embodiments. Accordingly, the landing page creation process takes place on an embodiment of the CRM frontend 103, the Web frontend 104. Further, at 601, the method 600 may include capturing general initial information for the landing page. Further, the initial information may include, but not limited to, landing Page name, Target Object, Post submit text Further, the landing page name may be associated with identifying name for the landing page. Further, all object referenced form fields are related to the target object. For example, an embodiment of the CRM Frontend 103 permits the selection of standard contact related objects. Further, the post submits text may include a final text to show to web user after submitting the form.

Further, at 602, the method 600 may require the definition of the form section itself. This includes three kinds of information, such as fields, questions, and comments. Further, the fields may be related to the target object previously defined. Further, the questions may include survey-related questions, not related to any particular object. Further, the comments may include a feedback field to capture comments and long text information from the web user.

All the fields, the questions, and the comments may include attributes controlling its behavior and user interface appearance. Further, the attributes may include but are not limited to, a label, an Order of display, a help text, a placeholder text, a requiredness, and a valid values list/ranges.

Further, at 603, the method 600 may require the definition of the landing page web layout. Further, a visual HTML drag & drop web builder may be shown that allows the creation of a web layout based on modules as well as customized HTML, CSS, images, and links. A particular module is included to place the previously generated form inside the layout.

Further, at 604, the method 600 may involve the definition of URL query parameters. The URL query parameters (or params) and fixed values are available at the form query string and are submitted within the form results. The URL query parameters may be related to the target object defined at 601, and enables additional tagging for the target object for every submitted record. Further, a name of a target grouping campaign may be defined, so all registered submits are grouped inside this campaign as campaign members, for example, this is particularly useful for an event registration form.

Further, at 605, the method 600 may include additional parameters such as an expiration date for the landing page that may be requested as well as a post submit redirect URL. Whenever the landing page is accessed after its expiration date, the landing page may not be shown and replaced by a customizable message that its not available anymore. After submitting a form, a post submit text is displayed to the web user, as defined at 601, and after that, it's redirected to a URL defined by this parameter.

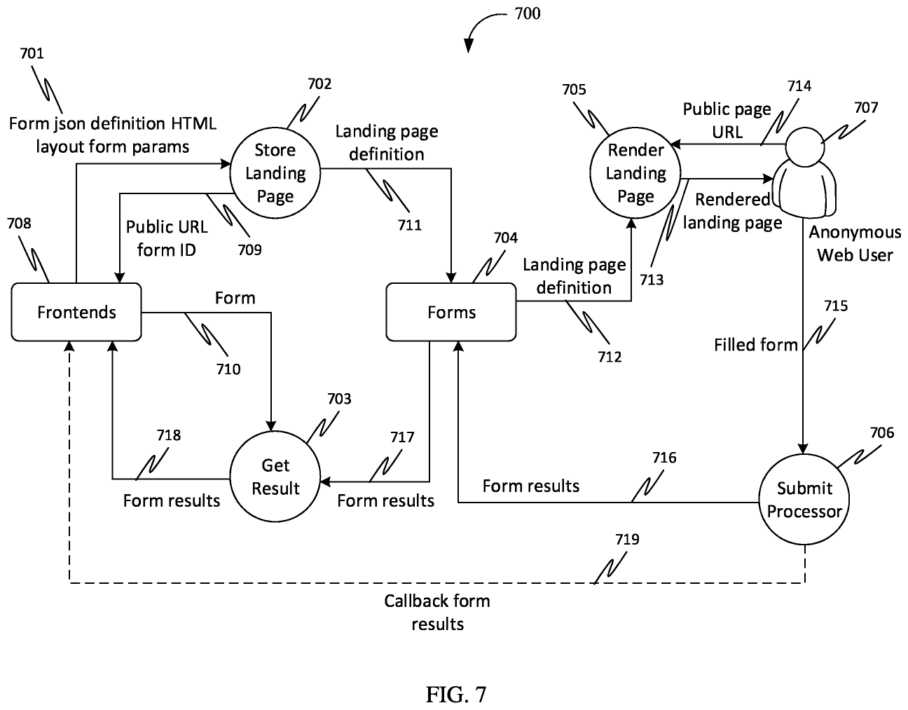

FIG. 7 is a flow diagram of a method 700 for landing page execution, in accordance with some embodiments. Accordingly, upon defining a landing page, the landing page is stored at 702, including its related HTML body and form Json definition code 701, into a Forms store 704 that belongs to an embodiment of the Internal Database 110. The Owned Web Channels Engine 107 assigns a public URL for it that may be sent back to the originating frontend for local reference.

Whenever a web user 707 accesses the public URL of the landing page, it's rendered using the HTML body and the Json form definition may be interpreted and the corresponding form may be also rendered at 705. The web user 707 fills and submits the form. The Owned Web Channels Engine 107 may process the submit at 706, persists the answers locally into the Internal Database 110 into the Forms store 704, and callbacks frontends 708 notifying the incoming results. Further, the callbacks frontends 708 may include the CRM frontend 103 and the Web frontend 104.

Further, the CRM frontend 103 and the Web frontend 104 at any time requests result in updates for a particular form at 703, that may be retrieved from the Forms store 704 and returned to them.

Further, at 709, the method 700 may include the public URL (or public URL form id). Further, at 710, the method 700 may include a form (or the particular form). Further, at 711, the method 700 may include landing page definition. Further, at 712, the method 700 may include landing page definition. Further, at 713, the method 700 may include a rendered landing page. Further, at 714, the method 700 may include a public page URL. Further, at 715, the method 700 may include a filled form. Further, at 716, the method 700 may include form results. Further, at 717, the method 700 may include the form results. Further, at 718, the method 700 may include the form results. Further, at 719, the method 700 may include callback form results.

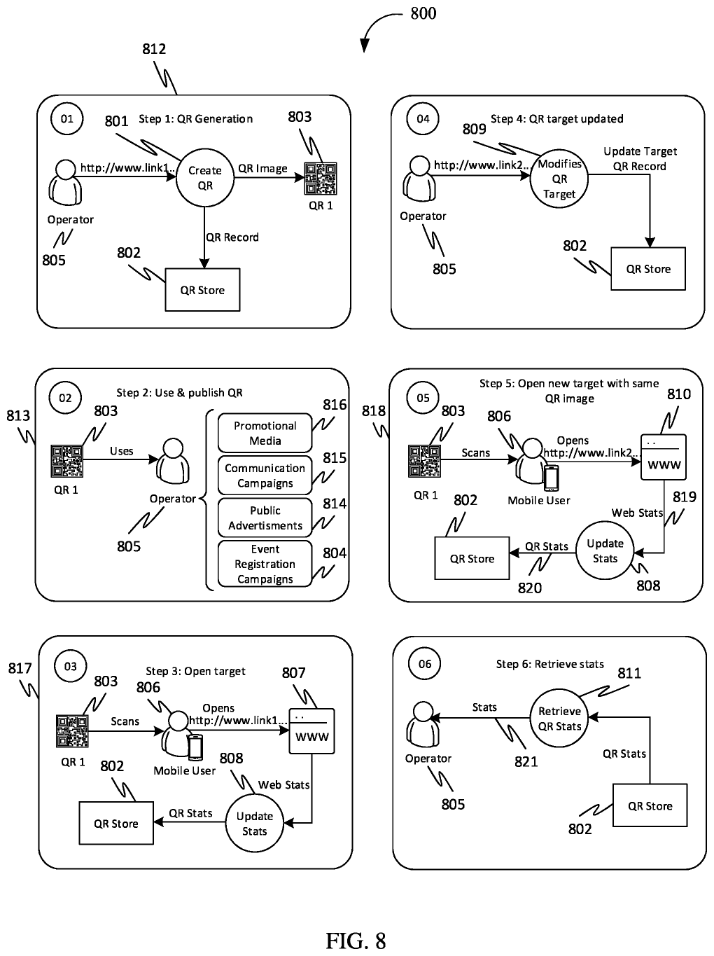

FIG. 8 illustrates a sample dynamic QR usage flow (method) 800, in accordance with some embodiments. Accordingly, at 812, the method 800 may include an operator user 805 of the CRM frontend 103 and the Web frontend 104 creating and defining a new QR record at 801, by providing its name and initial destination URL, included as part of the Owned Web Channels Engine 107. This process generates internally a QR image 803, and persist this record into a QR store 802, inside an embodiment of the Internal Database 110.

Further, upon generating the QR image 803, at 813, the method 800 may include the operator user 805 can make use of it on several publications, electronic marketing communications, communication campaigns 815, promotional media 816, public advertisements 814, event registrations campaigns 804, to name a few.

Further, at 817, upon scanning of the published QR image 803 by a mobile user 806, the mobile user 806 may be redirected to the target URL defined for that QR image 807. At that time, web statistics are collected, the QR record is updated with them and then persisted at 808 in the QR store 802.

Further, at 809, the operator user 805 of an embodiment of the CRM frontend 103 and the Web frontend 104 updates the target URL for the QR record and persists its changes in the QR store 802.

Further, at 818, the mobile user 806 may scan the published QR image 803 and may be redirected to a new target URL recently updated 810. Further, at 819, the method 800 may include web stats (or web statistics). Further, at 820, the method 800 may include transmitting the web statistics to the QR store 802.

Further, at 821, the operator user 805 of an embodiment of the CRM frontend 103 and the Web frontend 104 may request retrieval of the web statistics for a particular QR record that may be handled by an embodiment of a Retrieve QR Stats 811 process included as part of an embodiment of the Owned Web Channels Engine 107, fetching the available web statistics for the particular QR record in the QR store 802.

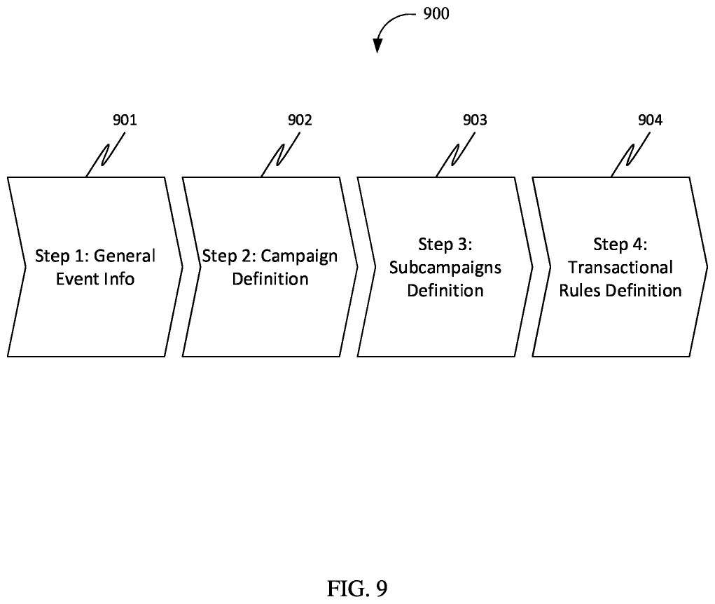

FIG. 9 is a flow diagram of a method 900 for facilitating event creation, in accordance with some embodiments. Accordingly, at 901, the Event Management Unit 115 may start its event definition by providing initial and general parameters. Further, the parameters (or general parameters) may include, but not limited to, event name, event Type/Subtype, key Event Start Datetime, key Event End Datetime, and event Location.

Further, at 902, the method 900 may include campaign definition. Further, the campaign definition may include creating a campaign. Further, the campaign holds the initial members that may be the target for the communicational sub-campaigns. When starting from an empty campaign, for example, where a web registration to the event is the main activity to capture members, there won't be any initial members at all. Further, if there are an already segmented subset of contact that may be summoned, they might be added as members.

Further, at 903, the method 900 may include sub-campaign creation. Further, in an event creation process within an embodiment of the Event Management Unit 115, allows the creation of the sub-campaigns related to the campaign (or main campaign) previously defined. Further, the sub-campaigns may be of different types, that may be expressed but not to be limited to, invitation, registration, confirmation, attendance, and gratitude.

Each one of the sub-campaigns has its communication channel definition, message, and media content and may populate from a subset of the original members, segmented by predefined criteria templates, that may be customized in real-time by the operator user, for example, “All invited members that have completed Registration and Confirmation”, or “All invited members that has recorded Attendance”+“and whose age >35 and age <55”. All of them have a triggering condition for its execution that may be one of these conditionals but not limited to manual start, scheduled start, particular absolute or relative date is reached.

In order to define and execute the sub-campaigns, the Event Management Unit 115 interacts with the Providers Operations Engine 114.

Further, at 904, the method 900 may include transactional rules definition. Further, the transactional rules definition may include several action rules for transactional notifications. Further, the transactional rules require the definition of the following parameters, but not limited to, a channel for the notification, templated content with contact merge fields, triggering criteria based on contact information, as well as event information or membership participation on any of the related sub-campaigns, time for notification, and absolute or relative DateTime for triggering the notification action.

Further, the parameter associated with the transactional rules may be are driven by an embodiment of the Event Management Unit 115 with a stretch interaction with an embodiment of the Sequence Automation Engine 109, for example, when a contact has recorded “Attendance”, then 2 days after the Key Event End Date, it sends an email greeting the member for attending the event.

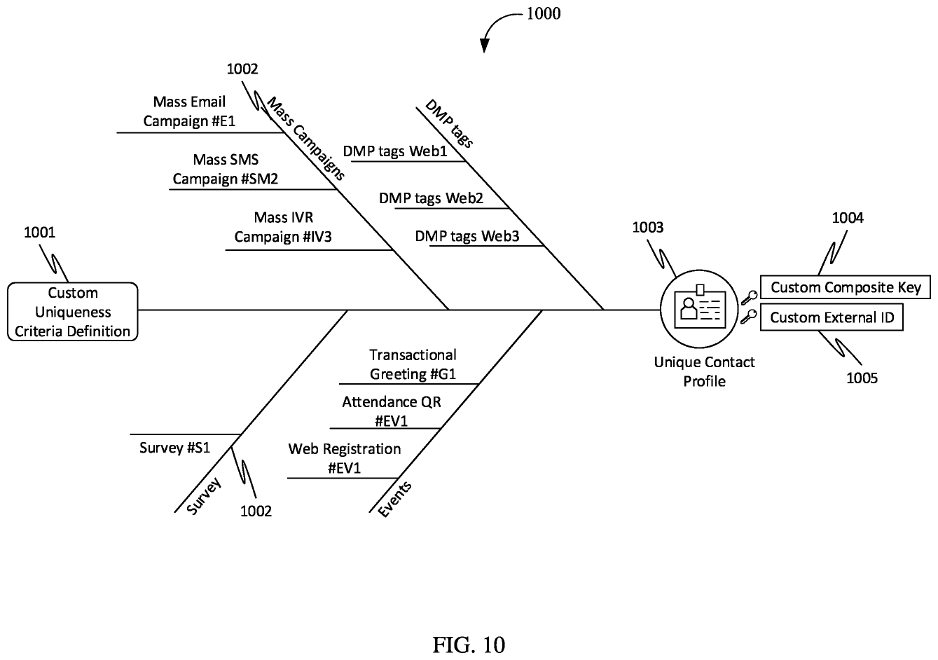

FIG. 10 is a schematic of a method 1000 for building a unified contact profile, in accordance with some embodiments. Accordingly, at 1001, the method 1000 may include custom uniqueness criteria definition. Further, the Data Quality, Uniqueness & Normalization Unit 118 may be configured for defining and keeping the matching rules that apply for each account in order to identify a unique contact.

Further, the uniqueness of a contact in the context of a particular client account may be defined by a set of fields that conform to a custom composite key 1004 (or composite key). Further, at 1002, the composite key 1004 may be applied to every interaction to record and group the participation of every unique contact record on the different campaigns/mass campaigns, transactional notifications, tags, forms/surveys filling, and QRs and short links accesses.

The composite key 1004 is mainly used at capturing new contact information or adding new members to campaigns, to match it to existing contacts and avoid duplicate records keeping the database quality at optimal levels.

Besides the composite key 1004, the contact record has an external ID field (or custom external ID) 1005 that acts as a full identifier field and relates to the requesting platform's unique ID for a record (or contact record). It's mainly used in links and communicational content as merge fields, for example, to link a survey to a particular existing contact.

The contact record and its related historical interactions shape a Unique Contact Profile at 1003.

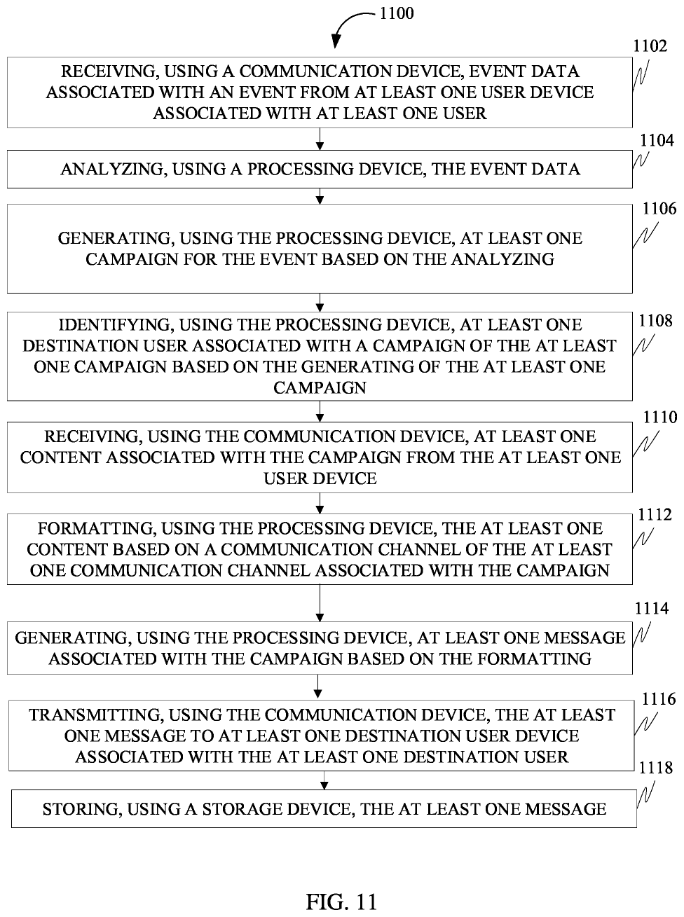

FIG. 11 is a flowchart of a method 1100 for facilitating communication between users and destination users using different communication channels, in accordance with some embodiments. Accordingly, at 1102, the method 1100 may include receiving, using a communication device, event data associated with an event from at least one user device associated with at least one user. Further, the event data may include an Event Name, an Event Type/Subtype, a Key Event Start Datetime, a Key Event End Datetime, an Event Location, etc. Further, the at least one user device may include a computing device such as a smartphone, a tablet, a desktop, a laptop, a smartwatch, and so on. Further, the at least one user may include at least one client, at least one operator user, etc.

Further, at 1104, the method 1100 may include analyzing, using a processing device, the event data.

Further, at 1106, the method 1100 may include generating, using the processing device, at least one campaign for the event based on the analyzing. Further, the at least one campaign may be characterized by at least one communication channel. Further, the at least one campaign may include an invitation campaign, a Registration campaign, a Confirmation campaign, an Attendance campaign, a Gratitude campaign, etc. Further, at least one of the at least one campaign may form a main campaign. Further, the at least one campaign may be associated with a communication channel definition, a message, a media content, a set of destination users. Further, the set of destination users may be segmented by at least one criterion. Further, the at least one communication channel may include a phone call, an email, a short messaging service (SMS), a near field communication (NFC), a QR communication channel, etc. Further, the message type of the message may include a phone call message, an email message, a SMS message, a NFC tag, a QR image, etc.

Further, at 1108, the method 1100 may include identifying, using the processing device, at least one destination user associated with a campaign of the at least one campaign based on the generating of the at least one campaign. Further, the at least one destination user may include at least one target user, at least one end-user, at least one audience, etc.

Further, at 1110, the method 1100 may include receiving, using the communication device, at least one content associated with the campaign from the at least one user device.

Further, at 1112, the method 1100 may include formatting, using the processing device, the at least one content based on a communication channel of the at least one communication channel associated with the campaign.

Further, at 1114, the method 1100 may include generating, using the processing device, at least one message associated with the campaign based on the formatting. Further, the at least one message may be characterized by a message type corresponding to the communication channel.

Further, at 1116, the method 1100 may include transmitting, using the communication device, the at least one message to at least one destination user device associated with the at least one destination user. Further, the at least one message may be transmitted using the communication channel. Further, the transmitting of the at least one message using the communication channel may be based on the formatting. Further, the at least one destination user device may include a computing device such as a smartphone, a tablet, a desktop, a laptop, a smartwatch, and so on.

Further, at 1118, the method 1100 may include storing, using a storage device, the at least one message.

Further, in some embodiments, the at least one content may include at least one uniform resource locator (URL). Further, the at least one message may include at least one QR image.

Further, in some embodiments, the method 1100 may further include a step of generating, using the processing device, a unique code corresponding to an interaction between a user of the at least one user and a destination user of the at least one destination user. Further, the interaction may include the at least one message. Further, the unique code may be associated with a plurality of communication channels of the at least one communication channel. Additionally, the method 1100 may include a step of storing, using the storage device, the unique code in association with the interaction. Further, the method 1100 may include a step of correlating, using the processing device, a plurality of interactions between the user and the destination user based on the unique code. Further, the plurality of interactions may be associated with the plurality of communication channels. Accordingly, in some embodiments, each record resulting from each interaction of a user (e.g. the destination user) over each channel may be associated with a corresponding unique code that allows identifying and/or validating the user across communication channels. Accordingly, as a result of one or multiple interactions, an unequivocal identification of an end user (e.g. the destination user) regardless of the type of interaction and channel used by the end user is made possible.

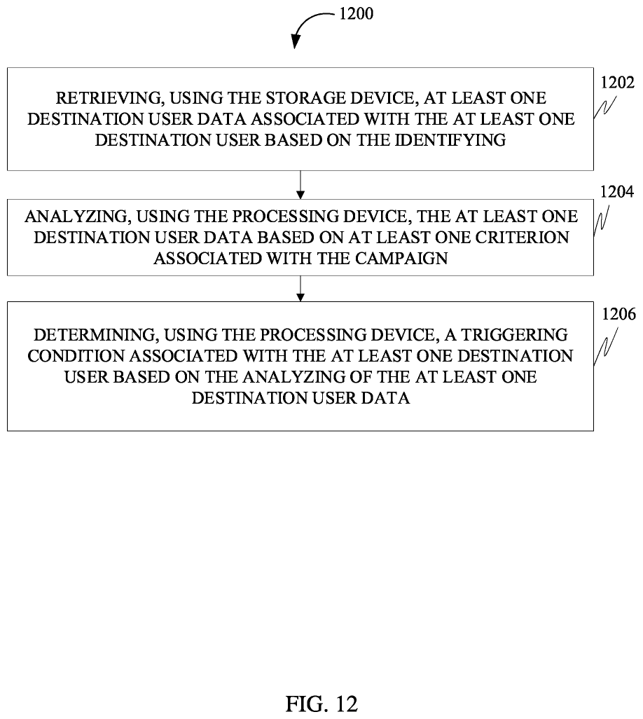

FIG. 12 is a flowchart of a method 1200 for determining a triggering condition for facilitating the communication between the users and the destination users using different communication channels, in accordance with some embodiments. Accordingly, at 1202, the method 1200 may include retrieving, using the storage device, at least one destination user data associated with the at least one destination user based on the identifying.

Further, at 1204, the method 1200 may include analyzing, using the processing device, the at least one destination user data based on at least one criterion associated with the campaign.

Further, at 1206, the method 1200 may include determining, using the processing device, the triggering condition associated with the at least one destination user based on the analyzing of the at least one destination user data. Further, the transmitting of the at least one message to the at least one destination user device associated with the at least one destination user may be further based on the triggering condition.

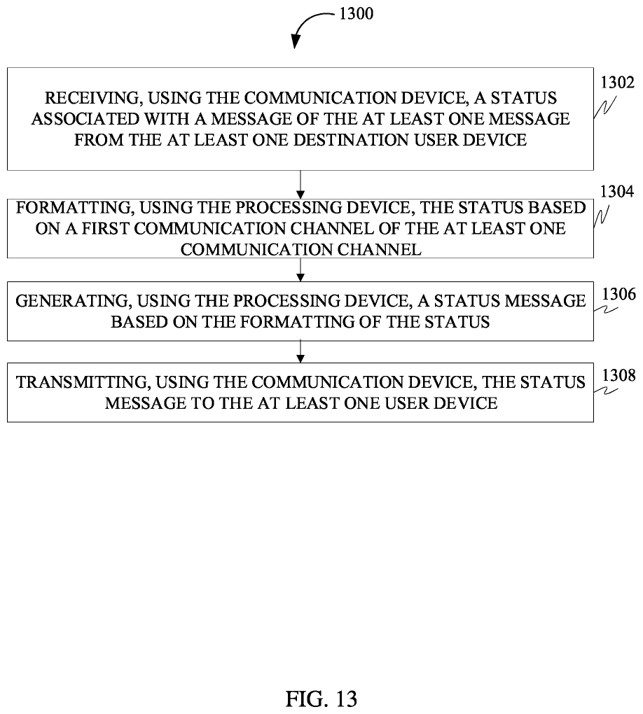

FIG. 13 is a flowchart of a method 1300 for generating a status message for facilitating the communication between the users and the destination users using different communication channels, in accordance with some embodiments. Accordingly, at 1302, the method 1300 may include receiving, using the communication device, a status associated with a message of the at least one message from the at least one destination user device. Further, the message may be associated with a first message type.

Further, at 1304, the method 1300 may include formatting, using the processing device, the status based on a first communication channel of the at least one communication channel. Further, the first communication channel may be different from the communication channel.

Further, at 1306, the method 1300 may include generating, using the processing device, the status message based on the formatting of the status. Further, the status message may be associated with a second message type. Further, the second message type may be different from the first message type.

Further, at 1308, the method 1300 may include transmitting, using the communication device, the status message to the at least one user device.

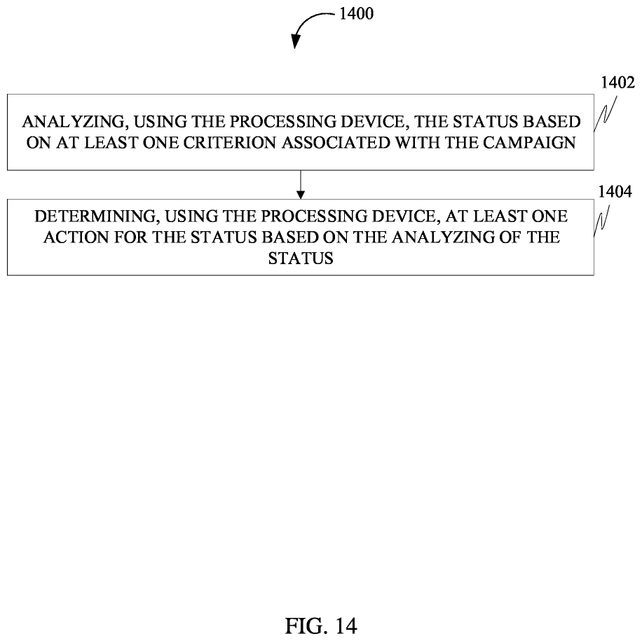

FIG. 14 is a flowchart of a method 1400 for determining at least one action for facilitating the communication between the users and the destination users using different communication channels, in accordance with some embodiments. Accordingly, at 1402, the method 1400 may include analyzing, using the processing device, the status based on at least one criterion associated with the campaign.

Further, at 1404, the method 1400 may include determining, using the processing device, the at least one action for the status based on the analyzing of the status. Further, the formatting of the status may be based on the determining of the at least one action. Further, the at least one action may include an immediate action, a scheduled action, etc. for sending the status to the at least one user device.

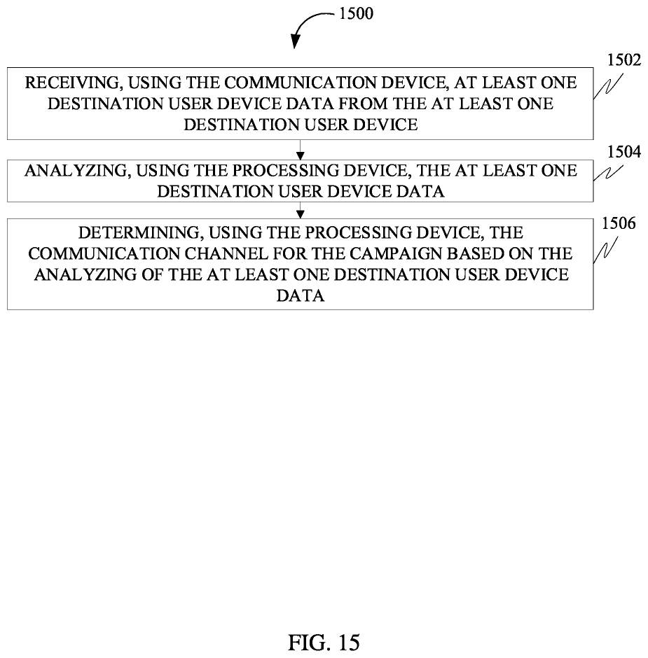

FIG. 15 is a flowchart of a method 1500 for determining the communication channel for facilitating the communication between the users and the destination users using different communication channels, in accordance with some embodiments. Accordingly, at 1502, the method 1500 may include receiving, using the communication device, at least one destination user device data from the at least one destination user device. Further, the at least one destination user device may be configured for generating the at least one destination user device data. Further, the at least one destination user device data may be associated with the at least one message. Further, the at least one destination user device data may include at least one user action performable by the at least one destination user using the at least one destination user device associated with the at least one message. Further, the at least one user action may include visiting at least one site associated with the at least one message, scanning a QR image of the at least one message, etc.

Further, at 1504, the method 1500 may include analyzing, using the processing device, the at least one destination user device data.

Further, at 1506, the method 1500 may include determining, using the processing device, the communication channel for the campaign based on the analyzing of the at least one destination user device data. Further, the formatting of the at least one content may be based on the determining of the communication channel.

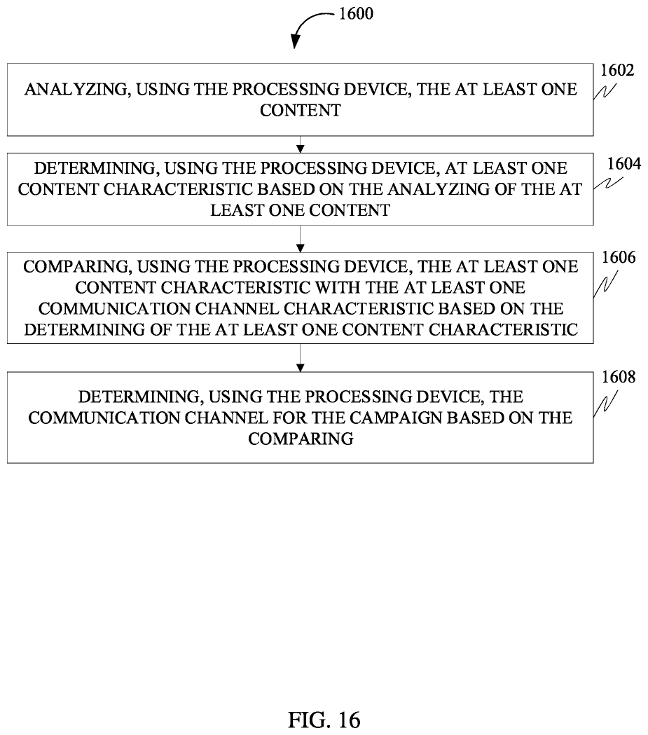

FIG. 16 is a flowchart of a method 1600 for determining the communication channel for facilitating the communication between the users and the destination users using different communication channels, in accordance with some embodiments. Accordingly, the at least one communication channel may be characterized by at least one communication channel characteristic. Further, the at least one communication channel characteristic may be associated with an ability of the at least one communication channel for delivering the at least one content to the at least one destination user device. Further, at 1602, the method 1600 may include analyzing, using the processing device, the at least one content.

Further, at 1604, the method 1600 may include determining, using the processing device, at least one content characteristic based on the analyzing of the at least one content. Further, the at least one content characteristic may be associated with a property of the at least one content such as a file size, a file format, a file quality, etc.

Further, at 1606, the method 1600 may include comparing, using the processing device, the at least one content characteristic with the at least one communication channel characteristic based on the determining of the at least one content characteristic.

Further, at 1608, the method 1600 may include determining, using the processing device, the communication channel for the campaign based on the comparing. Further, the formatting of the at least one content may be based on the determining of the communication channel.

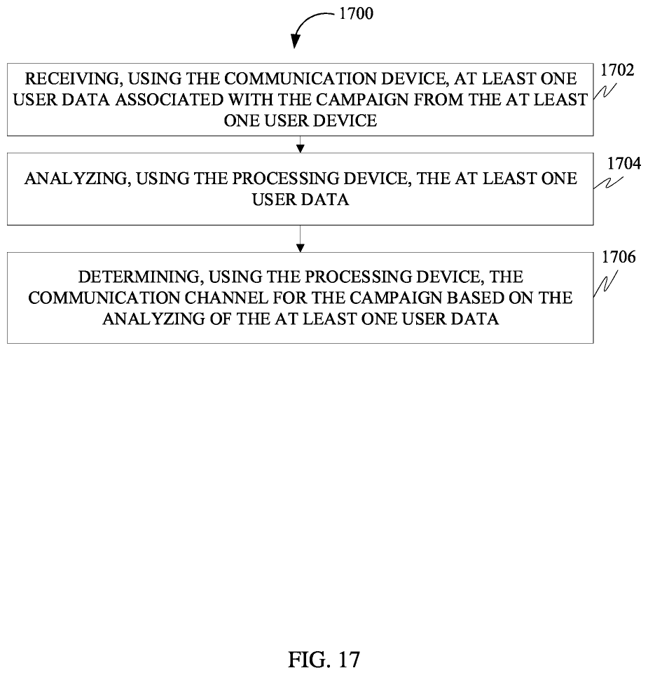

FIG. 17 is a flowchart of a method 1700 for determining the communication channel for facilitating the communication between the users and the destination users using different communication channels, in accordance with some embodiments.

Accordingly, at 1702, the method 1700 may include receiving, using the communication device, at least one user data associated with the campaign from the at least one user device. Further, the at least one user data may include an indication of the communication channel preferred by the at least one user.

Further, at 1704, the method 1700 may include analyzing, using the processing device, the at least one user data.

Further, at 1706, the method 1700 may include determining, using the processing device, the communication channel for the campaign based on the analyzing of the at least one user data. Further, the formatting of the at least one content may be based on the determining of the communication channel.

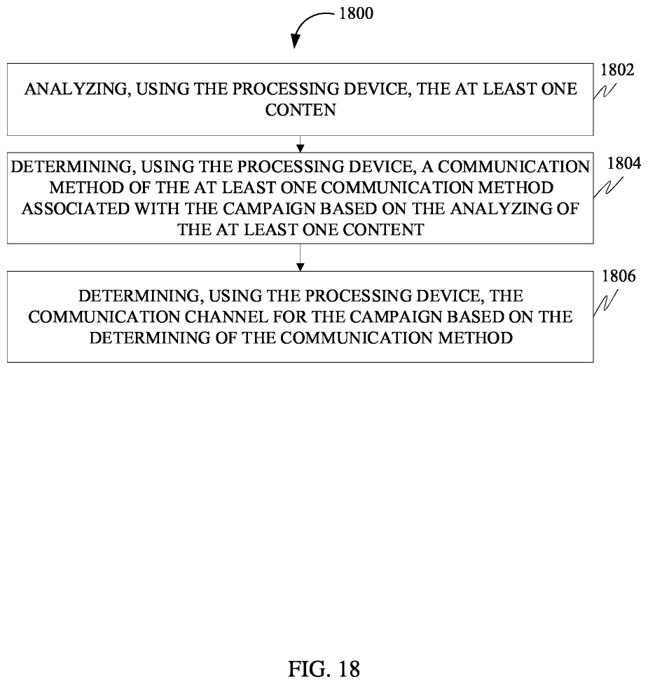

FIG. 18 is a flowchart of a method 1800 for determining a communication method for facilitating the communication between the users and the destination users using different communication channels, in accordance with some embodiments. Accordingly, the at least one campaign may be characterized by at least one communication method. Further, the at least one communication method may include one to one communication, one to many communication, many to many communication, etc. Further, at 1802, the method 1800 may include analyzing, using the processing device, the at least one content.

Further, at 1804, the method 1800 may include determining, using the processing device, the communication method of the at least one communication method associated with the campaign based on the analyzing of the at least one content.

Further, at 1806, the method 1800 may include determining, using the processing device, the communication channel for the campaign based on the determining of the communication method. Further, the formatting of the at least one content may be based on the determining of the communication channel.

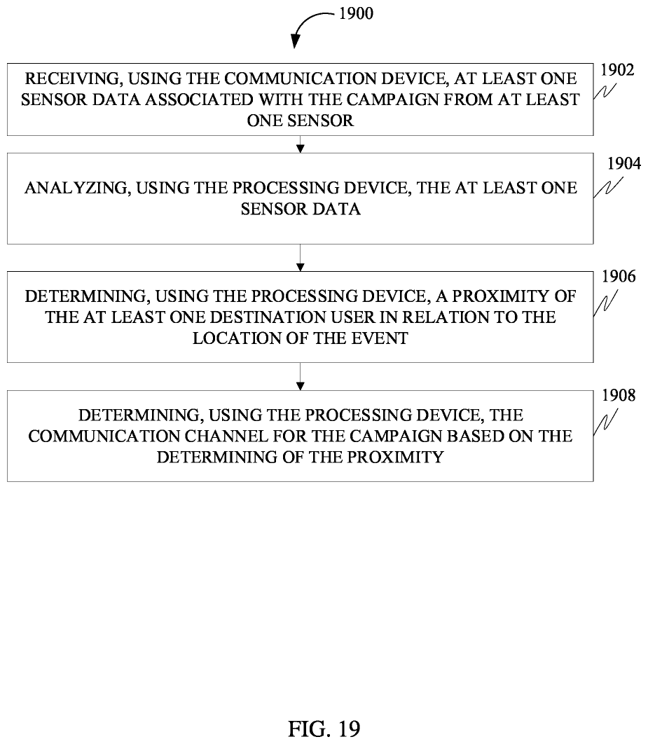

FIG. 19 is a flowchart of a method 1900 for determining a proximity for facilitating the communication between the users and the destination users using different communication channels, in accordance with some embodiments. Accordingly, at 1902, the method 1900 may include receiving, using the communication device, at least one sensor data associated with the campaign from at least one sensor. Further, the at least one sensor may be configured for generating the at least one sensor data based on a position of the at least one destination user in relation to a location of the event.

Further, at 1904, the method 1900 may include analyzing, using the processing device, the at least one sensor data.

Further, at 1906, the method 1900 may include determining, using the processing device, the proximity of the at least one destination user in relation to the location of the event.

Further, at 1908, the method 1900 may include determining, using the processing device, the communication channel for the campaign based on the determining of the proximity. Further, the formatting of the at least one content may be based on the determining of the communication channel.

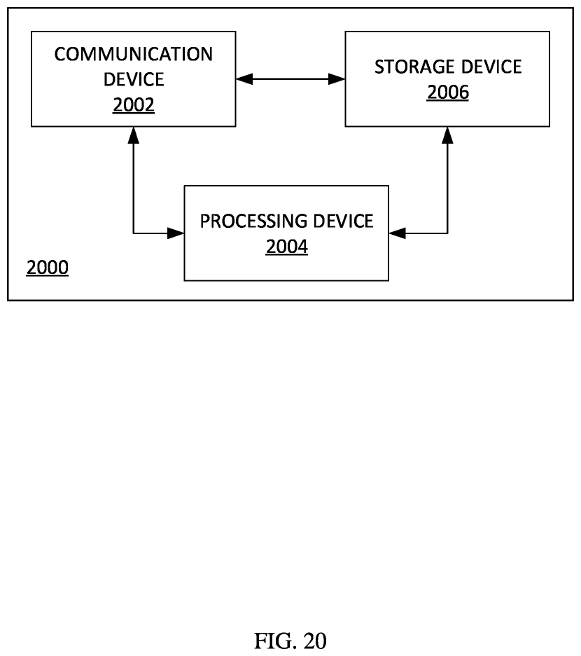

FIG. 20 is a block diagram of a system 2000 for facilitating communication between users and destination users using different communication channels, in accordance with some embodiments. Accordingly, the system 2000 may include a communication device 2002 configured for receiving event data associated with an event from at least one user device associated with at least one user. Further, the communication device 2002 may be configured for receiving at least one content associated with the campaign from the at least one user device. Further, the communication device 2002 may be configured for transmitting at least one message to at least one destination user device associated with at least one destination user. Further, the system 2000 may include a processing device 2004 communicatively coupled with the communication device 2002. Further, the processing device 2004 may be configured for analyzing the event data. Further, the processing device 2004 may be configured for generating at least one campaign for the event based on the analyzing. Further, the at least one campaign may be characterized by at least one communication channel. Further, the processing device 2004 may be configured for identifying the at least one destination user associated with a campaign of the at least one campaign based on the generating of the at least one campaign. Further, the processing device 2004 may be configured for formatting the at least one content based on a communication channel of the at least one communication channel associated with the campaign. Further, the processing device 2004 may be configured for generating the at least one message associated with the campaign based on the formatting. Further, the at least one message may be characterized by a message type corresponding to the communication channel. Further, the system 2000 may include a storage device 2006 communicatively coupled with the processing device 2004. Further, the storage device 2006 may be configured for storing the at least one message.

Further, in some embodiments, the storage device 2006 may be configured for retrieving at least one destination user data associated with the at least one destination user based on the identifying. Further, the processing device 2004 may be configured for analyzing the at least one destination user data based on at least one criterion associated with the campaign. Further, the processing device 2004 may be configured for determining a triggering condition associated with the at least one destination user based on the analyzing of the at least one destination user data. Further, the transmitting of the at least one message to the at least one destination user device associated with the at least one destination user may be based on the triggering condition.

Further, in some embodiments, the communication device 2002 may be configured for receiving a status associated with a message of the at least one message from the at least one destination user device. Further, the message may be associated with a first message type. Further, the communication device 2002 may be configured for transmitting a status message to the at least one user device. Further, the processing device 2004 may be configured for formatting the status based on a first communication channel of the at least one communication channel. Further, the first communication channel may be different from the communication channel. Further, the processing device 2004 may be configured for generating the status message based on the formatting of the status. Further, the status message may be associated with a second message type. Further, the second message type may be different from the first message type.

Further, in some embodiments, the processing device 2004 may be configured for analyzing the status based on at least one criterion associated with the campaign. Further, the processing device 2004 may be configured for determining at least one action for the status based on the analyzing of the status. Further, the formatting of the status may be based on the determining of the at least one action.

Further, in some embodiments, the communication device 2002 may be configured for receiving, at least one destination user device data from the at least one destination user device. Further, the processing device 2004 may be configured for analyzing, the at least one destination user device data. Further, the processing device 2004 may be configured for determining, the communication channel for the campaign based on the analyzing of the at least one destination user device data. Further, the formatting of the at least one content may be based on the determining of the communication channel.

Further, in some embodiments, the at least one communication channel may be characterized by at least one communication channel characteristic. Further, the processing device 2004 may be configured for analyzing the at least one content. Further, the processing device 2004 may be configured for determining at least one content characteristic based on the analyzing of the at least one content. Further, the processing device 2004 may be configured for comparing the at least one content characteristic with the at least one communication channel characteristic based on the determining of the at least one content characteristic. Further, the processing device 2004 may be configured for determining the communication channel for the campaign based on the comparing. Further, the formatting of the at least one content may be based on the determining of the communication channel.

Further, in some embodiments, the communication device 2002 may be configured for receiving at least one user data associated with the campaign from the at least one user device. Further, the processing device 2004 may be configured for analyzing the at least one user data. Further, the processing device 2004 may be configured for determining the communication channel for the campaign based on the analyzing of the at least one user data. Further, the formatting of the at least one content may be based on the determining of the communication channel.

Further, in some embodiments, the at least one campaign may be characterized by at least one communication method. Further, the processing device 2004 may be configured for analyzing the at least one content. Further, the processing device 2004 may be configured for determining a communication method of the at least one communication method associated with the campaign based on the analyzing of the at least one content. Further, the processing device 2004 may be configured for determining the communication channel for the campaign based on the determining of the communication method. Further, the formatting of the at least one content may be based on the determining of the communication channel.

Further, in some embodiments, the communication device 2002 may be configured for receiving at least one sensor data associated with the campaign from at least one sensor. Further, the at least one sensor may be configured for generating the at least one sensor data based on a position of the at least one destination user in relation to a location of the event. Further, the processing device 2004 may be configured for analyzing the at least one sensor data. Further, the processing device 2004 may be configured for determining a proximity of the at least one destination user in relation to the location of the event. Further, the processing device 2004 may be configured for determining the communication channel for the campaign based on the determining of the proximity. Further, the formatting of the at least one content may be based on the determining of the communication channel.

Further, in some embodiments, the at least one content may include at least one uniform resource locator (URL). Further, the at least one message may include at least one QR image.

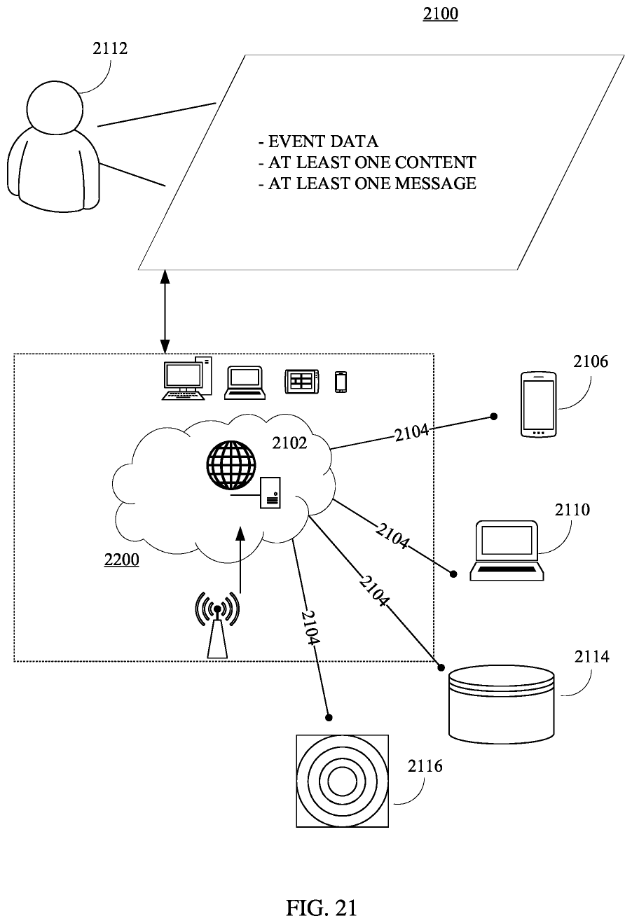

FIG. 21 is an illustration of an online platform 2100 consistent with various embodiments of the present disclosure. By way of non-limiting example, the online platform 2100 to facilitate communication between users and destination users using different communication channels may be hosted on a centralized server 2102, such as, for example, a cloud computing service. The centralized server 2102 may communicate with other network entities, such as, for example, a mobile device 2106 (such as a smartphone, a laptop, a tablet computer etc.), other electronic devices 2110 (such as desktop computers, server computers etc.), databases 2114, and sensors 2116 over a communication network 2104, such as, but not limited to, the Internet. Further, users of the online platform 2100 may include relevant parties such as, but not limited to, end-users, administrators, service providers, service consumers and so on. Accordingly, in some instances, electronic devices operated by the one or more relevant parties may be in communication with the platform.

A user 2112, such as the one or more relevant parties, may access online platform 2100 through a web based software application or browser. The web based software application may be embodied as, for example, but not be limited to, a website, a web application, a desktop application, and a mobile application compatible with a computing device 2200.

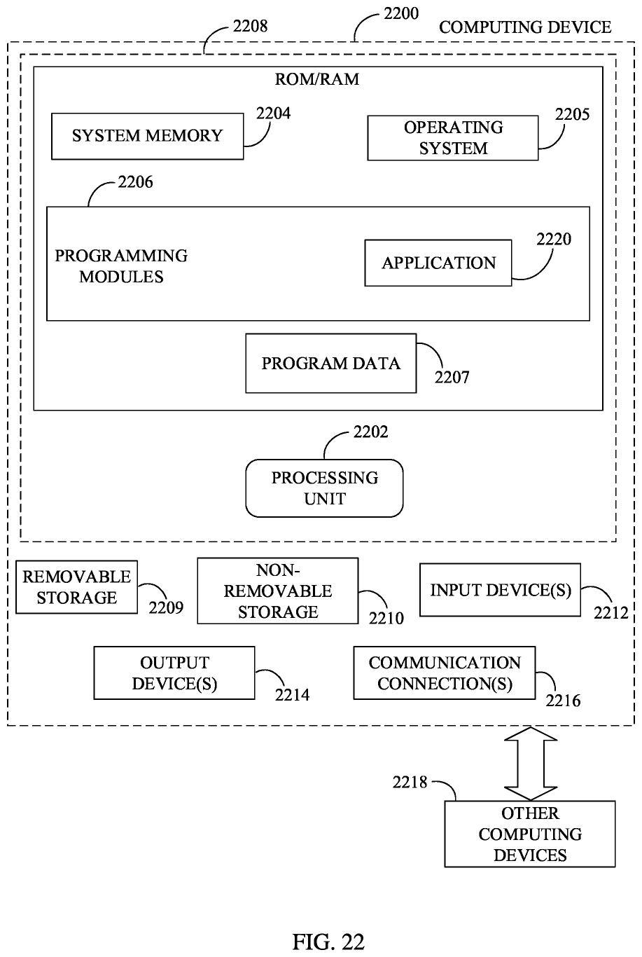

With reference to FIG. 22, a system consistent with an embodiment of the disclosure may include a computing device or cloud service, such as computing device 2200. In a basic configuration, computing device 2200 may include at least one processing unit 2202 and a system memory 2204. Depending on the configuration and type of computing device, system memory 2204 may comprise, but is not limited to, volatile (e.g. random-access memory (RAM)), non-volatile (e.g. read-only memory (ROM)), flash memory, or any combination. System memory 2204 may include operating system 2205, one or more programming modules 2206, and may include a program data 2207. Operating system 2205, for example, may be suitable for controlling computing device 2200's operation. In one embodiment, programming modules 2206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

Computing device 2200 may have additional features or functionality. For example, computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and non-volatile, removable and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2200. Any such computer storage media may be part of device 2200. Computing device 2200 may also have input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used.

Computing device 2200 may also contain a communication connection 2216 that may allow device 2200 to communicate with other computing devices 2218, such as over a network in a distributed computing environment, for example, an intranet or the Internet. Communication connection 2216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2204, including operating system 2205. While executing on processing unit 2202, programming modules 2206 (e.g., application 2220) may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating communication between users and destination users using different communication channels, the method comprising:
receiving, using a communication device, event data associated with an event from at least one user device associated with at least one user;
analyzing, using a processing device, the event data;
generating, using the processing device, at least one campaign for the event based on the analyzing, wherein the at least one campaign is characterized by at least one communication channel;
identifying, using the processing device, at least one destination user associated with a campaign of the at least one campaign based on the generating of the at least one campaign;
receiving, using the communication device, at least one content associated with the campaign from the at least one user device;
formatting, using the processing device, the at least one content based on a communication channel of the at least one communication channel associated with the campaign;
generating, using the processing device, at least one message associated with the campaign based on the formatting, wherein the at least one message is characterized by a message type corresponding to the communication channel;
transmitting, using the communication device, the at least one message to at least one destination user device associated with the at least one destination user; and
storing, using a storage device, the at least one message.

2. The method of claim 1 further comprising:
retrieving, using the storage device, at least one destination user data associated with the at least one destination user based on the identifying;
analyzing, using the processing device, the at least one destination user data based on at least one criterion associated with the campaign; and
determining, using the processing device, a triggering condition associated with the at least one destination user based on the analyzing of the at least one destination user data, wherein the transmitting of the at least one message to the at least one destination user device associated with the at least one destination user is further based on the triggering condition.

3. The method of claim 1 further comprising:
receiving, using the communication device, a status associated with a message of the at least one message from the at least one destination user device, wherein the message is associated with a first message type;
formatting, using the processing device, the status based on a first communication channel of the at least one communication channel, wherein the first communication channel is different from the communication channel;
generating, using the processing device, a status message based on the formatting of the status, wherein the status message is associated with a second message type, wherein the second message type is different from the first message type; and
transmitting, using the communication device, the status message to the at least one user device.

4. The method of claim 3 further comprising:
analyzing, using the processing device, the status based on at least one criterion associated with the campaign; and
determining, using the processing device, at least one action for the status based on the analyzing of the status, wherein the formatting of the status is further based on the determining of the at least one action.

5. The method of claim 1 further comprising:
receiving, using the communication device, at least one destination user device data from the at least one destination user device;
analyzing, using the processing device, the at least one destination user device data; and
determining, using the processing device, the communication channel for the campaign based on the analyzing of the at least one destination user device data, wherein the formatting of the at least one content is further based on the determining of the communication channel.

6. The method of claim 1, wherein the at least one communication channel is characterized by at least one communication channel characteristic, wherein the method further comprises:
analyzing, using the processing device, the at least one content;
determining, using the processing device, at least one content characteristic based on the analyzing of the at least one content;
comparing, using the processing device, the at least one content characteristic with the at least one communication channel characteristic based on the determining of the at least one content characteristic; and
determining, using the processing device, the communication channel for the campaign based on the comparing, wherein the formatting of the at least one content is further based on the determining of the communication channel.

7. The method of claim 1 further comprising:
receiving, using the communication device, at least one user data associated with the campaign from the at least one user device;
analyzing, using the processing device, the at least one user data; and
determining, using the processing device, the communication channel for the campaign based on the analyzing of the at least one user data, wherein the formatting of the at least one content is further based on the determining of the communication channel.

8. The method of claim 1, wherein the at least one campaign is characterized by at least one communication method, wherein the method further comprises:
analyzing, using the processing device, the at least one content;
determining, using the processing device, a communication method of the at least one communication method associated with the campaign based on the analyzing of the at least one content; and
determining, using the processing device, the communication channel for the campaign based on the determining of the communication method, wherein the formatting of the at least one content is further based on the determining of the communication channel.

9. The method of claim 1 further comprising:
receiving, using the communication device, at least one sensor data associated with the campaign from at least one sensor, wherein the at least one sensor is configured for generating the at least one sensor data based on a position of the at least one destination user in relation to a location of the event;
analyzing, using the processing device, the at least one sensor data;
determining, using the processing device, a proximity of the at least one destination user in relation to the location of the event; and
determining, using the processing device, the communication channel for the campaign based on the determining of the proximity, wherein the formatting of the at least one content is further based on the determining of the communication channel.

10. The method of claim 1, wherein the at least one content comprises at least one uniform resource locator (URL), wherein the at least one message comprises at least one QR image.

11. The method of claim 1 further comprising:
generating, using the processing device, a unique code corresponding to an interaction between a user of the at least one user and a destination user of the at least one destination user, wherein the interaction comprises the at least one message, wherein the unique code is associated with a plurality of communication channels of the at least one communication channel;
storing, using the storage device, the unique code in association with the interaction; and
correlating, using the processing device, a plurality of interactions between the user and the destination user based on the unique code, wherein the plurality of interactions is associated with the plurality of communication channels.

12. A system for facilitating communication between users and destination users using different communication channels, the system comprising:
a communication device configured for:
receiving event data associated with an event from at least one user device associated with at least one user;
receiving at least one content associated with the campaign from the at least one user device; and
transmitting at least one message to at least one destination user device associated with at least one destination user;
a processing device communicatively coupled with the communication device, the processing device is configured for:
analyzing the event data;
generating at least one campaign for the event based on the analyzing, wherein the at least one campaign is characterized by at least one communication channel;
identifying the at least one destination user associated with a campaign of the at least one campaign based on the generating of the at least one campaign;
formatting the at least one content based on a communication channel of the at least one communication channel associated with the campaign; and
generating the at least one message associated with the campaign based on the formatting, wherein the at least one message is characterized by a message type corresponding to the communication channel; and
a storage device communicatively coupled with the processing device, wherein the storage device is configured for storing the at least one message.

13. The system of claim 12, wherein the storage device is further configured for retrieving at least one destination user data associated with the at least one destination user based on the identifying, wherein the processing device is further configured for:
analyzing the at least one destination user data based on at least one criterion associated with the campaign; and
determining a triggering condition associated with the at least one destination user based on the analyzing of the at least one destination user data, wherein the transmitting of the at least one message to the at least one destination user device associated with the at least one destination user is further based on the triggering condition.

14. The system of claim 12, wherein the communication device is further configured for:
receiving a status associated with a message of the at least one message from the at least one destination user device, wherein the message is associated with a first message type; and
transmitting a status message to the at least one user device, wherein the processing device is further configured for:
formatting the status based on a first communication channel of the at least one communication channel, wherein the first communication channel is different from the communication channel; and
generating the status message based on the formatting of the status, wherein the status message is associated with a second message type, wherein the second message type is different from the first message type.

15. The system of claim 14, wherein the processing device is further configured for:
analyzing the status based on at least one criterion associated with the campaign; and
determining at least one action for the status based on the analyzing of the status, wherein the formatting of the status is further based on the determining of the at least one action.

16. The system of claim 12, wherein the communication device is further configured for receiving, at least one destination user device data from the at least one destination user device, wherein the processing device is further configured for:
analyzing, the at least one destination user device data; and
determining, the communication channel for the campaign based on the analyzing of the at least one destination user device data, wherein the formatting of the at least one content is further based on the determining of the communication channel.

17. The system of claim 12, wherein the at least one communication channel is characterized by at least one communication channel characteristic, wherein the processing device is further configured for:
analyzing the at least one content;
determining at least one content characteristic based on the analyzing of the at least one content;
comparing the at least one content characteristic with the at least one communication channel characteristic based on the determining of the at least one content characteristic; and
determining the communication channel for the campaign based on the comparing, wherein the formatting of the at least one content is further based on the determining of the communication channel.

18. The system of claim 12, wherein the communication device is further configured for receiving at least one user data associated with the campaign from the at least one user device, wherein the processing device is further configured for:
analyzing the at least one user data; and
determining the communication channel for the campaign based on the analyzing of the at least one user data, wherein the formatting of the at least one content is further based on the determining of the communication channel.

19. The system of claim 12, wherein the at least one campaign is characterized by at least one communication method, wherein the processing device is further configured for:
analyzing the at least one content;
determining a communication method of the at least one communication method associated with the campaign based on the analyzing of the at least one content; and
determining the communication channel for the campaign based on the determining of the communication method, wherein the formatting of the at least one content is further based on the determining of the communication channel.

20. The system of claim 12, wherein the communication device is further configured for receiving at least one sensor data associated with the campaign from at least one sensor, wherein the at least one sensor is configured for generating the at least one sensor data based on a position of the at least one destination user in relation to a location of the event, wherein the processing device is further configured for:
analyzing the at least one sensor data;
determining a proximity of the at least one destination user in relation to the location of the event; and
determining the communication channel for the campaign based on the determining of the proximity, wherein the formatting of the at least one content is further based on the determining of the communication channel.

21. The system of claim 12, wherein the at least one content comprises at least one uniform resource locator (URL), wherein the at least one message comprises at least one QR image.

22. The system of claim 12, wherein the processing device is further configured for:
generating a unique code corresponding to an interaction between a user of the at least one user and a destination user of the at least one destination user, wherein the interaction comprises the at least one message, wherein the unique code is associated with a plurality of communication channels of the at least one communication channel; and
correlating a plurality of interactions between the user and the destination user based on the unique code, wherein the plurality of interactions is associated with the plurality of communication channels, wherein the storage device is further configured for storing the unique code in association with the interaction.
